(19) United States
(12) Patent Application Publication
(10) Pub. No.: US 2021/0053010 A1
(43) Pub. Date: Feb. 25, 2021

(54) HUMIDITY CONTROL DEVICE AND SEPARATION DEVICE

(71) Applicant: SHARP KABUSHIKI KAISHA, Sakai City, Osaka (JP)

(72) Inventors: JUN SAKUMA, Sakai City, Osaka (JP); SHO OCHI, Sakai City, Osaka (JP); TETSUYA IDE, Sakai City, Osaka (JP); TSUYOSHI KAMADA, Sakai City, Osaka (JP); HIROKA HAMADA, Sakai City, Osaka (JP); MAKOTO YAMADA, Sakai City, Osaka (JP)

(73) Assignee: SHARP KABUSHIKI KAISHA, Sakai City, Osaka (JP)

(21) Appl. No.: 16/961,212

(22) PCT Filed: Dec. 17, 2018
(86) PCT No.: PCT/JP2018/046392

§ 371 Date: Jul. 9, 2020

(30) Foreign Application Priority Data
Jan. 10, 2018 (JP) 2018-002172

(51) Int. Cl. B01D 53/26; B01D 53/14; B01D 45/16; F24F 11/00

(52) U.S. Cl. CPC B01D 53/263; F24F 11/0008; B01D 45/16; B01D 53/1425

(57) ABSTRACT

A humidity control device includes: a storage unit that stores hygroscopic liquid that contains a hygroscopic substance; a vent that is provided in the storage unit; absorption means by which air and the hygroscopic liquid are brought into contact with each other and moisture contained in the air is absorbed by the hygroscopic liquid; an ultrasonic wave generation unit that irradiates at least a part of the hygroscopic liquid, which has absorbed the moisture, with an ultrasonic wave; and removal means by which an atomized droplet that is generated is removed from the hygroscopic liquid that has absorbed the moisture, in which the storage unit suppresses an outflow of a coarse droplet whose particle size is larger than that of the atomized droplet.

### TECHNICAL FIELD

The present invention relates to a humidity control device and a separation device.

This application claims priority based on Japanese Patent Application No. 2018-002172 filed in Japan on Jan. 10, 2018, the content of which is incorporated herein.

### BACKGROUND ART

A humidity control element with an absorbent is conventionally known and widely used in a humidity control device or the like (refer to PTL 1). The humidity control element includes a support body that has, for example, a honeycomb shape or a corrugated cardboard shape and a plurality of air flow paths are formed by the support body.

Moreover, on a surface of the support body, a powdery adsorbent made of an inorganic material such as zeolite, silica gel, or activated carbon is held by a binder. Then, when air flows in an air flow path of the humidity control element, the absorbent absorbs water vapor or the like in the air so that the air is able to be dried.

### CITATION LIST

### Patent Literature

PTL 1: Japanese Unexamined Patent Application Publication No. 2001-149737

### SUMMARY OF INVENTION

### Technical Problem

For repetitive use, a dehumidifier (humidity control device) described in PTL 1 needs to absorb (absorb) moisture from air to be processed and then desorb (separate) the absorbed moisture to recover performance of absorbing moisture. However, since a conventional dehumidifier that uses a dehumidifying agent (absorbent) brings a change in a state of moisture from liquid to gas when the absorbed moisture is desorbed, energy that is equal to or more than an amount of latent heat of absorbed water needs to be added. Thus, the conventional dehumidifier has a problem that a large amount of power is consumed.

An aspect of the invention is made in view of such circumstances and an object thereof is to provide a humidity control device capable of performing absorption and desorption of moisture with low power consumption. Moreover, an object thereof is to provide a separation device applicable to the humidity control device.

### Solution to Problem

The inventors have focused on water separation utilizing atomization with use of an ultrasonic wave. The inventors have examined a device that irradiates hygroscopic liquid, which absorbs moisture, with an ultrasonic wave to generate an atomized droplet from the hygroscopic liquid, and removes the atomized droplet to thereby separate the moisture from the hygroscopic liquid. Such a device does not bring a change in a state of the moisture from liquid to gas when the moisture is desorbed. Thus, the device described above is able to perform absorption and desorption of the moisture with low power consumption.

The inventors have found that a humidity control device having the following aspects is able to suppress leakage of a hygroscopic substance contained in hygroscopic liquid and keep dehumidification efficiency even after repetitive use, and have completed the invention.

An aspect of the invention provides a humidity control device that includes: a storage unit that stores hygroscopic liquid that contains a hygroscopic substance; a vent that is provided in the storage unit; absorption means by which air and the hygroscopic liquid are brought into contact with each other and moisture contained in the air is absorbed by the hygroscopic liquid; an ultrasonic wave generation unit that irradiates at least a part of the hygroscopic liquid, which has absorbed the moisture, with an ultrasonic wave; and removal means by which an atomized droplet that is generated is removed from the hygroscopic liquid that has absorbed the moisture, in which the storage unit suppresses an outflow of a coarse droplet whose particle size is larger than that of the atomized droplet.

An aspect of the invention may have a configuration in which a collection unit that collects at least a part of the atomized droplet is included.

An aspect of the invention may have a configuration in which the storage unit includes a separation unit that separates the atomized droplet and the coarse droplet.

An aspect of the invention may have a configuration in which the separation unit includes a cyclone separator.

An aspect of the invention may have a configuration in which the separation unit includes a demister.

An aspect of the invention may have a configuration in which the vent includes a first vent and a second vent, the storage unit includes a first storage unit, a second storage unit, and a flow path by which the first storage unit and the second storage unit are connected, the first storage unit includes the absorption means and the first vent, and the second storage unit includes the ultrasonic wave generation unit, the removal means, and the second vent.

An aspect of the invention may have a configuration in which the vent is provided in a side part of the storage unit, the storage unit is provided with a pipe that includes a connection portion connected to the vent, one end of the pipe is opened in an outside of the storage unit, and the pipe is inclined so that the connection portion is located below the one end of the pipe.

An aspect of the invention may have a configuration in which the pipe is curved or bent.

An aspect of the invention may have a configuration in which the pipe extends to an inside of the storage unit so that the other end of the pipe is located below the connection portion.

An aspect of the invention may have a configuration in which the vent is provided in a side part of the storage unit, the storage unit is provided with a pipe that includes a connection portion connected to the vent, one end of the pipe is opened in an outside of the storage unit, and the pipe extends to an inside of the storage unit so that the other end of the pipe is located below the connection portion.

An aspect of the invention may have a configuration in which the storage unit includes a separation unit that separates the atomized droplet and the coarse droplet.

An aspect of the invention may have a configuration in which the separation unit includes a demister.

An aspect of the invention may have a configuration in which the demister is provided in an inside of at least any one of the storage unit and the pipe.

An aspect of the invention may have a configuration in which the vent includes a first vent and a second vent, the storage unit includes a first storage unit, a second storage unit, and a flow path by which the first storage unit and the second storage unit are connected, the first storage unit includes the absorption means and the first vent, the second storage unit includes the ultrasonic wave generation unit, the removal means, the second vent, and the pipe, and the pipe is connected to the second vent.

An aspect of the invention provides a separation device that separates solvent from solution, the separation device includes: a storage unit that stores the solution; a collection unit that collects the solvent that is separated; an ultrasonic wave generation unit that irradiates at least a part of the solution with an ultrasonic wave; a swirl flow generation unit that generates a swirl flow of gas in an inside of the storage unit; and a pipe by which the storage unit and the collection unit are connected, in which the swirl flow causes an atomized droplet that is generated from the solution to be separated so that the solvent is separated, and an outflow of a coarse droplet whose particle size is larger than that of the atomized droplet is suppressed.

### Advantageous Effects of Invention

According to an aspect of the invention, a humidity control device capable of performing absorption and desorption of moisture with low power consumption is provided. Moreover, a separation device applicable to the humidity control device is provided.

### BRIEF DESCRIPTION OF DRAWINGS

FIG. 1 illustrates a schematic configuration of a humidity control device 10 of a first embodiment.

FIG. 2 illustrates a schematic configuration of a humidity control device 110 of a second embodiment.

FIG. 3 illustrates a schematic configuration of a humidity control device 210 of a third embodiment.

FIG. 4 illustrates a schematic configuration of a modified example of a second air discharge flow path 218.

FIG. 5 illustrates a schematic configuration of another modified example of the second air discharge flow path 218.

FIG. 6 illustrates a schematic configuration of a humidity control device 310 of a fourth embodiment.

FIG. 7 illustrates a schematic configuration of a humidity control device 410 of a fifth embodiment.

FIG. 8 illustrates a schematic configuration of a humidity control device 510 of a sixth embodiment.

FIG. 9 illustrates a part of a schematic configuration of a modified example of the humidity control device 10 of the first embodiment.

### DESCRIPTION OF EMBODIMENTS

### First Embodiment

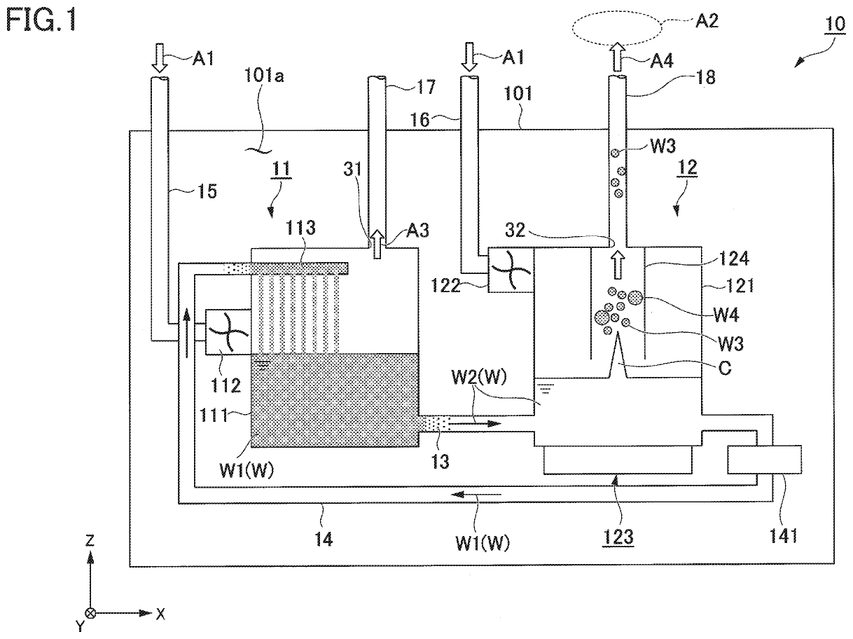

Hereinafter, a humidity control device and a humidity control method in a first embodiment of the invention will be described with reference to FIG. 1.

Note that, in the drawings used in the following description, for a purpose of emphasizing a feature portion, the feature portion may be illustrated in an enlarged manner for convenience, and a dimensional ratio or the like of components is not always the same as an actual one. Furthermore, for a similar purpose, illustration of a portion other than the feature portion may be omitted. In a three-dimensional orthogonal coordinate system (XYZ coordinate system) illustrated in each of the drawings as appropriate, a Z-axis direction is defined as a vertical direction. An X-axis direction and a Y-axis direction are each defined as one direction in a horizontal direction orthogonal to the Z-axis direction, and are defined as directions orthogonal to each other.

The humidity control method of the present embodiment includes: a moisture absorption step in which hygroscopic liquid containing a hygroscopic substance is brought into contact with air so that the hygroscopic liquid absorbs moisture contained in the air; and a regeneration step in which the moisture is separated from the hygroscopic liquid that has absorbed the moisture.

In the present specification, “regeneration” means that moisture is separated from hygroscopic liquid that has absorbed the moisture and performance of absorbing the moisture of the hygroscopic liquid is recovered.

### Humidity Control Device

FIG. 1 illustrates a schematic configuration of a humidity control device 10 of the first embodiment. As illustrated in FIG. 1, the humidity control device 10 of the present embodiment includes a housing 101, a moisture absorption unit 11, a regeneration unit 12, a first liquid transport flow path 13, a second liquid transport flow path 14, a first air supply flow path 15, a second air supply flow path 16, a first air discharge flow path 17, a second air discharge flow path 18, a blower 112, a blower 122, a nozzle unit 113, and an ultrasonic wave generation unit 123. Note that, the humidity control device 10 may include a control unit (not illustrated) that controls driving of the ultrasonic wave generation unit 123, a pump 141, the blower 112, the blower 122, and the like.

The moisture absorption unit 11, the regeneration unit 12, the first liquid transport flow path 13, and the second liquid transport flow path 14 are examples of a storage unit in the claims. The moisture absorption unit 11 is an example of a first storage unit in the claims. The regeneration unit 12 is an example of a second storage unit in the claims.

The blower 112 and the nozzle unit 113 are examples of absorption means in the claims.

The blower 122 is an example of removal means in the claims.

The housing 101 of the present embodiment includes an inner space 101a. The housing 101 of the present embodiment accommodates at least the moisture absorption unit 11 and the regeneration unit 12 in the inner space 101a.

The moisture absorption unit 11 and the regeneration unit 12 store hygroscopic liquid W. The hygroscopic liquid W will be described later.

In the following description, liquid used for processing in the moisture absorption unit 11 is referred to as “hygroscopic liquid W1”. Moreover, liquid processed in the regeneration unit 12 is referred to as “hygroscopic liquid W2”. Note that, a collective configuration of the hygroscopic liquid W1 and the hygroscopic liquid W2 is referred to as “hygroscopic liquid W”.

In the present specification, the “hygroscopic liquid W2” is an example of “hygroscopic liquid that has absorbed moisture” in the claims.

Moreover, in the following description, air processed in the moisture absorption unit 11 is referred to as “air A1”. Additionally, air discharged from the moisture absorption unit 11 is referred to as “air A3”. Furthermore, air discharged from the regeneration unit 12 is referred to as “air A4”. Air mixed with the “air A4” is referred to as “air A2”.

The air A1 and the air A2 exist in a temporally or spatially different manner. In a case of existing in the temporally different manner, the air A1 and the air A2 according to the invention exist in the same space. In a case of existing in the spatially different manner, the air A1 and the air A2 exist in the same time.

In the following embodiment, the case where the air A1 and the air A2 exist in the temporally different manner will be described.

Through the first liquid transport flow path 13 and the second liquid transport flow path 14, the hygroscopic liquid W is transported. Through the first liquid transport flow path 13, the hygroscopic liquid W is transported from the moisture absorption unit 11 to the regeneration unit 12. Through the second liquid transport flow path 14, the hygroscopic liquid W is transported from the regeneration unit 12 to the moisture absorption unit 11. The pump 141 that circulates the hygroscopic liquid W is connected to a middle of the second liquid transport flow path 14.

Through the first air supply flow path 15, the air A1 is supplied from an outside of the housing 101 to an inner space of the moisture absorption unit 11.

Through the second air supply flow path 16, the air A1 is supplied from the outside of the housing 101 to an inner space of the regeneration unit 12.

Through the first air discharge flow path 17, the air A3 is discharged from the inner space of the moisture absorption unit 11 to the outside of the housing 101.

Through the second air discharge flow path 18, the air A4 is discharged from the inner space of the regeneration unit 12 to the outside of the housing 101.

### Moisture Absorption Unit

The moisture absorption unit 11 sends the air A1 outside the housing 101 to the inner space of the moisture absorption unit 11 so that the air A1 is brought into contact with the hygroscopic liquid W1 in the inner space and moisture contained in the air A1 is absorbed by the hygroscopic liquid W1. The moisture absorption unit 11 includes a first storage tank 111.

The first storage tank 111 stores the hygroscopic liquid W1. The blower 112 and the first air discharge flow path 17 are connected to an upper part of the first storage tank 111. The second liquid transport flow path 14 is connected to the first storage tank 111 in a part above a liquid surface of the hygroscopic liquid W1. The first liquid transport flow path 13 is connected to the first storage tank 111 in a part below the liquid surface of the hygroscopic liquid W1.

One end of the first air supply flow path 15 is connected to the blower 112. On the other hand, the other end of the first air supply flow path 15 is opened in the outside of the housing 101.

A vent 31 is provided in an upper part of the first storage tank 111. One end of the first air discharge flow path 17 is connected to the vent 31. On the other hand, the other end of the first air discharge flow path 17 is opened in the outside of the housing 101.

The vent 31 is an example of a first vent in the claims.

The blower 112 supplies the air A1 to the inner space of the first storage tank 111 via the first air supply flow path 15. The air A1 delivered by the blower 112 forms an air flow directed from the blower 112 to the vent 31 of the first storage tank 111.

The nozzle unit 113 causes the hygroscopic liquid W1 to drop in a substantially circular shape in a gravity direction in the inner space of the first storage tank 111. At this time, in the inner space of the first storage tank 111, since the air flow of the air A1 is generated by the blower 112, the air A1 and the hygroscopic liquid W1 are able to be brought into contact with each other. In this manner, the moisture contained in the air A1 is absorbed by the hygroscopic liquid W1. A contact system of the air A1 and the hygroscopic liquid W1 in the present embodiment is typically called a flow-down system. The nozzle unit 113 is arranged above the liquid surface of the hygroscopic liquid W1 stored in the first storage tank 111. The nozzle unit 113 is connected to the other end of the second liquid transport flow path 14.

The air A3 obtained by the moisture absorption unit 11 is obtained by removing the moisture from the air A1 and is thus drier than the air A1.

### Regeneration Unit

The regeneration unit 12 irradiates a part of the hygroscopic liquid W2 with an ultrasonic wave and generates an atomized droplet W3 from the hygroscopic liquid W2 to thereby remove moisture from the hygroscopic liquid W2 and suppress an outflow of a coarse droplet W4 whose particle size is larger than that of the atomized droplet W3. The regeneration unit 12 includes a second storage tank 121 and a guide pipe 124.

The second storage tank 121 is an example of a separation unit in the claims.

The second storage tank 121 stores the hygroscopic liquid W2. Moreover, the second storage tank 121 is a so-called cyclone separator that separates the atomized droplet W3 and the coarse droplet W4 by a swirl flow formed by the blower 122, which is described later.

The blower 122 and the second air discharge flow path 18 are connected to an upper part of the second storage tank 121. The first liquid transport flow path 13 and the second liquid transport flow path 14 are connected to the second storage tank 121 in a part below a liquid surface of the hygroscopic liquid W2.

One end of the second air supply flow path 16 is connected to the blower 122. On the other hand, the other end of the second air supply flow path 16 is arranged in the outside of the housing 101.

A vent 32 is provided in an upper part of the second storage tank 121. One end of the second air discharge flow path 18 is connected to the vent 32 of the second storage tank 121. On the other hand, the other end of the second air discharge flow path 18 is opened in the outside of the housing 101.

The vent 32 is an example of a second vent in the claims.

The blower 122 supplies the air A1 to the inner space of the second storage tank 121 via the second air supply flow path 16. The air A1 supplied by the blower 122 forms a swirl flow directed from the blower 122 to the vent 32 of the second storage tank 121.

Note that, a device having a suction function may be provided in a middle of the second air discharge flow path 18, instead of the blower 122.

The ultrasonic wave generation unit 123 irradiates a part of the hygroscopic liquid W2 with an ultrasonic wave and generates, from the hygroscopic liquid W2, droplets that contain moisture. The ultrasonic wave generation unit 123 is in contact with the regeneration unit 12 in a lower part (−Z direction) of the second storage tank 121.

The droplets generated from the hygroscopic liquid W2 include not only the atomized droplet W3 but also the coarse droplet W4 whose particle size is larger than that of the atomized droplet W3. The particle size of the atomized droplet W3 is in a range from nano-order to submicron-order. The particle size of the coarse droplet W4 is micron-order. The particle sizes of the droplets are able to be obtained by measurement with use of a light scattering method, measurement with use of an electrical aerosol analyzer (EAA), or the like.

The particle sizes of the droplets generated from the hygroscopic liquid W2 depend on a type of the hygroscopic liquid W described later, but are affected by a frequency of the ultrasonic wave, input power of the ultrasonic wave generation unit 123, or the like. An intermolecular force between a water molecule and a hygroscopic substance is weaker than an intermolecular force between water molecules. Thus, it is considered that the atomized droplet W3 whose particle size is small is difficult to contain the hygroscopic substance. On the other hand, it is considered that the coarse droplet W4 whose particle size is large is easy to contain the hygroscopic substance. Additionally, when the hygroscopic liquid W2 is irradiated with the ultrasonic wave, a phenomenon in which a droplet of the hygroscopic liquid W2 splashes occurs in some cases. It is considered that the coarse droplet W4 is generated also by the phenomenon.

The inventors have found that, in order to keep dehumidification efficiency of the humidity control device 10, by suppressing an outflow of the coarse droplet W4 generated from the hygroscopic liquid W2, it is possible to suppress leakage of the hygroscopic substance, and have completed the invention.

When the ultrasonic wave generation unit 123 irradiates the hygroscopic liquid W2 with the ultrasonic wave, a liquid column C of the hygroscopic liquid W2 is generated in the liquid surface of the hygroscopic liquid W2 in some cases. A large number of atomized droplets W3 described above are generated from the liquid column C.

The ultrasonic wave generation unit 123 is planarly overlapped with the vent 32 of the second storage tank 121 when the humidity control device 10 is viewed from above. According to such a positional relationship between the ultrasonic wave generation unit 123 and the vent 32, when the humidity control device 10 is viewed from above, the liquid column C is generated at a position where the ultrasonic wave generation unit 123 is planarly overlapped with the vent 32.

The frequency of the ultrasonic wave is preferably in a range of, for example, 1.0 MHz or more and 5.0 MHz or less. When the frequency of the ultrasonic wave is in the range, the ultrasonic wave generation unit 123 easily generates the atomized droplet W3.

The input power of the ultrasonic wave generation unit 123 is preferably, for example, 2 W or more, more preferably 10 W or more. When the input power of the ultrasonic wave generation unit 123 is 2 W or more, the ultrasonic wave generation unit 123 easily generates the atomized droplet W3.

The humidity control device 10 easily generates the atomized droplet W3 also by adjusting depth from a surface of the ultrasonic wave generation unit 123 to the liquid surface of the hygroscopic liquid W2.

Depth from a bottom surface of the second storage tank 121 to the liquid surface of the hygroscopic liquid W2 is preferably in a range of 1 cm or more and 6 cm or less. When the depth is 1 cm or more, a risk of empty heating is low and the ultrasonic wave generation unit 123 easily generates the atomized droplet W3. Moreover, when the depth is 6 cm or less, the liquid column C of the hygroscopic liquid W2 is easily generated. As a result, the ultrasonic wave generation unit 123 is able to efficiently generate the atomized droplet W3.

The guide pipe 124 guides, to the vent 32 of the second air discharge flow path 18, the atomized droplet W3 generated from the hygroscopic liquid W2. When the humidity control device 10 is viewed from above, the guide pipe 124 planarly surrounds the vent 32 of the second air discharge flow path 18.

In the regeneration unit 12, according to a positional relationship among the ultrasonic wave generation unit 123, the guide pipe 124, and the vent 32, the guide pipe 124 surrounds the liquid column C. Thereby, a swirl flow directed upward from the liquid surface of the hygroscopic liquid W2 conveys the atomized droplet W3 whose particle size is small to the vent 32. On the other hand, the coarse droplet W4 whose particle size is larger than that of the atomized droplet W3 is left out of the swirl flow and is left in the inner space of the second storage tank 121.

The air A4 obtained by the regeneration unit 12 contains the generated atomized droplet W3, and is thus more humid than the air A2 outside the housing 101.

### Hygroscopic Liquid

The hygroscopic liquid W of the present embodiment is liquid that exhibits hygroscopicity and is preferably liquid that exhibits hygroscopicity at 25° C. and a relative humidity of 50%, and under atmospheric pressure.

The hygroscopic liquid W of the present embodiment contains a hygroscopic substance. Moreover, the hygroscopic liquid W of the present embodiment may contain a hygroscopic substance and a solvent. As such a solvent, a solvent that dissolves the hygroscopic substance or that is mixed with the hygroscopic substance is used, and an example thereof includes water.

The hygroscopic substance may be an organic material or an inorganic material.

Examples of the organic material used as the hygroscopic substance include dihydric or higher alcohol, ketone, an organic solvent having amide group, saccharides, and a known material used as a raw material for moisturizing cosmetics etc.

Particularly, the dihydric or higher alcohol, the organic solvent having amide group, the saccharides, or the known material used as the raw material for moisturizing cosmetics etc. is preferable as the organic material used as the hygroscopic substance because of having high hydrophilicity.

Examples of the dihydric or higher alcohol include glycerin, propanediol, butanediol, pentanediol, trimethylolpropane, butanetriol, ethylene glycol, diethylene glycol, and triethylene glycol.

Examples of the organic solvent having amide group include formamide and acetamide.

Examples of the saccharides include sucrose, pullulan, glucose, fructose, mannitol, and sorbitol.

Examples of the known material used as the raw material for moisturizing cosmetics etc. include 2-methacryloyloxyethyl phosphoryl choline (MPC), betaine, hyaluronic acid, and collagen.

Examples of the inorganic material used as the hygroscopic substance include calcium chloride, lithium chloride, magnesium chloride, potassium chloride, sodium chloride, zinc chloride, aluminum chloride, lithium bromide, calcium bromide, potassium bromide, sodium hydroxide, and sodium pyrrolidone carboxylate.

In a case where hydrophilicity of the hygroscopic substance is high, for example, when such a material is mixed with water, a ratio of water molecules in a vicinity of a surface (liquid surface) of the hygroscopic liquid W is high. The regeneration unit 12 generates the atomized droplet W3 from the vicinity of the surface of the hygroscopic liquid W2 to separate moisture from the hygroscopic liquid W2. Thus, when the ratio of water molecules in the vicinity of the surface of the hygroscopic liquid W is high, the moisture is able to be efficiently separated.

Moreover, a ratio of the hygroscopic substance in the vicinity of the surface of the hygroscopic liquid W becomes relatively low. Thus, it is possible to suppress leakage of the hygroscopic substance at the regeneration step.

In the hygroscopic liquid W of the present embodiment, content concentration of a hygroscopic substance relative to total mass of the hygroscopic liquid W1 is not particularly limited, but is preferably 40 mass % or more. When the content concentration of the hygroscopic substance is 40 mass % or more, the hygroscopic liquid W1 is able to efficiently absorb moisture.

Viscosity of the hygroscopic liquid W of the present embodiment is preferably 25 mPa·s or less. Thereby, the liquid column C of the hygroscopic liquid W2 is easily generated in the liquid surface of the hygroscopic liquid W2. Thus, the moisture is able to be efficiently separated from the hygroscopic liquid W2.

### Humidity Control Method

Hereinafter, a humidity control method using the humidity control device 10 described above will be described.

The humidity control method of the present embodiment includes: a moisture absorption step in which hygroscopic liquid containing a hygroscopic substance is brought into contact with air by the moisture absorption unit 11, the blower 112, and the nozzle unit 113 so that the hygroscopic liquid absorbs moisture contained in the air; and a regeneration step in which the moisture is separated, by the regeneration unit 12, the blower 122, and the ultrasonic wave generation unit 123, from the hygroscopic liquid that has absorbed the moisture.

In the moisture absorption step of the present embodiment, the blower 112 is driven to supply the air A1 outside the housing 101 to the inner space of the first storage tank 111. At this time, in the inner space of the first storage tank 111, an air flow of the air A1 is formed. On the other hand, the hygroscopic liquid W1 regenerated in the second storage tank 121 is transported from the second storage tank 121 to the first storage tank 111 by the pump 141, and then gravitationally drops from the nozzle unit 113 in the inner space of the first storage tank 111. Thereby, the hygroscopic liquid W1 is brought into contact with the air A1 and moisture contained in the air A1 is absorbed by the hygroscopic liquid W1. The air A3 obtained by removing the moisture from the air A1 is discharged to the outside of the housing 101 from the vent 31 of the first storage tank 111.

In the regeneration step of the present embodiment, the ultrasonic wave generation unit 123 is driven to irradiate a part of the hygroscopic liquid W2 with an ultrasonic wave and generate the atomized droplet W3 from the hygroscopic liquid W2. Meanwhile, in the regeneration step of the present embodiment, the blower 122 is driven to supply the air A1 outside the housing 101 to the inner space of the second storage tank 121 via the second air supply flow path 16. At this time, in the inner space of the second storage tank 121, a swirl flow directed from the blower 122 to the vent 32 of the second storage tank 121 is formed. The swirl flow discharges the air A4 that contains the atomized droplet W3 from the vent 32 of the second storage tank 121 to the air A2 outside the housing 101. On the other hand, the coarse droplet W4 whose particle size is larger than that of the atomized droplet W3 is left out of the swirl flow and is left in the inner space of the second storage tank 121. The hygroscopic liquid W1 obtained by removing moisture is transported from the second storage tank 121 to the first storage tank 111 by the pump 141 and reused in the aforementioned moisture absorption step.

The humidity control device of the present embodiment uses an ultrasonic wave to regenerate the hygroscopic liquid W2. Thus, it is considered that the humidity control device of the present embodiment hardly brings a change in a state of water, which is used when a conventional humidity control device regenerates a hygroscopic form. Accordingly, the humidity control device of the present embodiment is able to regenerate the hygroscopic liquid with low energy.

According to the humidity control device of the present embodiment, it is possible to discharge the atomized droplet W3 and suppress an outflow of a coarse droplet containing a hygroscopic liquid. Thereby, the humidity control device of the present embodiment is able to suppress leakage of hygroscopic liquid. Accordingly, the humidity control device of the present embodiment is able to keep dehumidification efficiency even in a case where the humidity control device 10 is repeatedly used.

### Second Embodiment

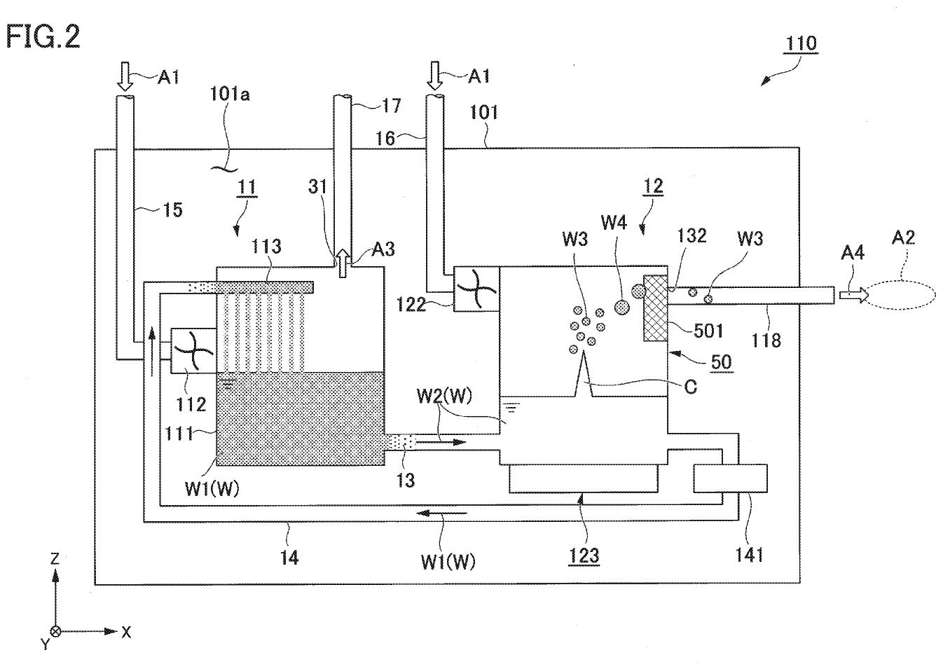

Hereinafter, a humidity control device and a humidity control method in a second embodiment of the invention will be described with reference to FIG. 2.

### Humidity Control Device

FIG. 2 illustrates a schematic configuration of a humidity control device 110 of the second embodiment. As illustrated in FIG. 2, the humidity control device 110 of the second embodiment includes the housing 101, the moisture absorption unit 11, the regeneration unit 12, the first liquid transport flow path 13, the second liquid transport flow path 14, the first air supply flow path 15, the second air supply flow path 16, the first air discharge flow path 17, a second air discharge flow path 118, the blower 112, the blower 122, the nozzle unit 113, the ultrasonic wave generation unit 123, and a separation unit 50. Accordingly, a component common to that of the first embodiment will be denoted by the same reference sign in the present embodiment, and detailed description thereof will be omitted.

Through the second air discharge flow path 118, the air A4 is discharged from the inner space of the regeneration unit 12 to the outside of the housing 101.

A vent 132 is provided in a side part of the second storage tank 121. One end of the second air discharge flow path 118 is connected to the vent 132. On the other hand, the other end of the second air discharge flow path 118 is opened in the outside of the housing 101.

### Separation Unit 50

The separation unit 50 separates an atomized droplet and a coarse droplet when the air A4 that contains droplets generated from the hygroscopic liquid W2 passes. The separation unit 50 includes a demister 501.

The demister 501 separates the coarse droplet W4 from the air A4 that contains the droplets generated from the hygroscopic liquid W2. The demister 501 covers the vent 132 of the second storage tank 121 from an inner side of the second storage tank 121. A size of a mesh of the demister 501 is larger than the particle size of the atomized droplet W3 and smaller than the particle size of the coarse droplet W4.

### Humidity Control Method

Hereinafter, a humidity control method using the humidity control device 110 described above will be described. The humidity control method of the present embodiment includes a moisture absorption step and a regeneration step. The moisture absorption step of the present embodiment is similar to that of the first embodiment.

In the regeneration step of the present embodiment, the ultrasonic wave generation unit 123 is driven to irradiate a part of the hygroscopic liquid W2 with an ultrasonic wave and generate the atomized droplet W3 from the hygroscopic liquid W2. Meanwhile, in the regeneration step of the present embodiment, the blower 122 is driven to supply the air A1 outside the housing 101 to the inner space of the second storage tank 121 via the second air supply flow path 16. At this time, in the inner space of the second storage tank 121, an air flow directed from the blower 122 to the vent 132 of the second storage tank 121 is formed.

The air flow directed from the blower 122 to the vent 132 discharges the air A4 that contains the atomized droplet W3 and the coarse droplet W4 from the vent 132 of the second storage tank 121 to the air A2 outside the housing 101. At this time, the atomized droplet W3 passes through the demister 501 of the separation unit 50 and is discharged to the outside of the housing 101 via the second air discharge flow path 118. On the other hand, the coarse droplet W4 whose particle size is larger than that of the atomized droplet W3 is collected by the demister 501 of the separation unit 50. The collected coarse droplet W4 gravitationally drops and is returned to the hygroscopic liquid W2 in the second storage tank 121.

The humidity control device of the present embodiment is able to regenerate the hygroscopic liquid with low energy, similarly to the humidity control device of the first embodiment.

According to the humidity control device of the present embodiment, it is possible to suppress leakage of a hygroscopic substance, similarly to the humidity control device of the first embodiment. Accordingly, the humidity control device of the present embodiment is able to keep dehumidification efficiency even in a case where the humidity control device 10 is repeatedly used, similarly to the humidity control device of the first embodiment.

### Third Embodiment

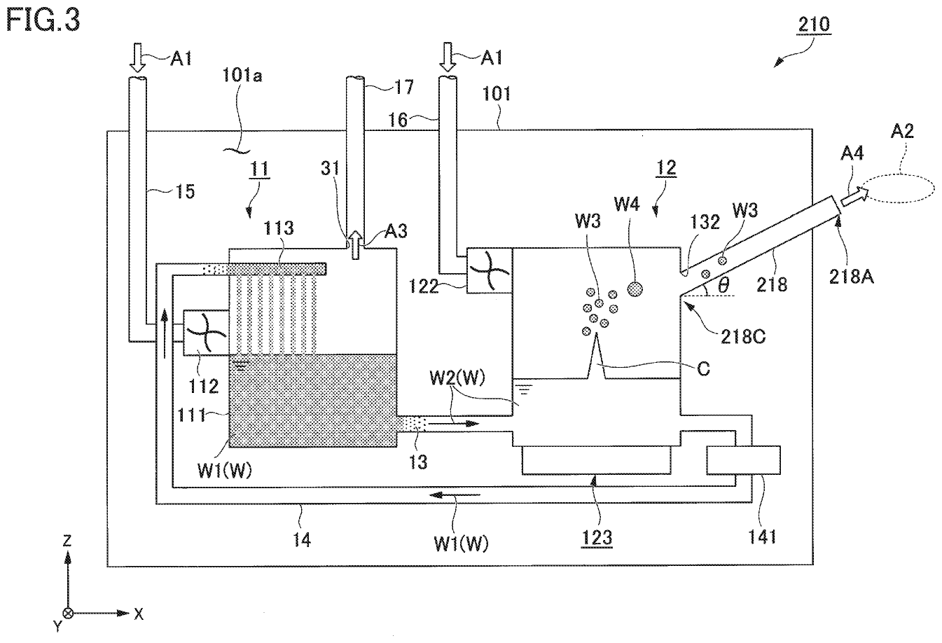

Hereinafter, a humidity control device in a third embodiment of the invention will be described with reference to FIG. 3.

### Humidity Control Device

FIG. 3 illustrates a schematic configuration of a humidity control device 210 of the third embodiment. As illustrated in FIG. 3, the humidity control device 210 of the third embodiment includes the housing 101, the moisture absorption unit 11, the regeneration unit 12, the first liquid transport flow path 13, the second liquid transport flow path 14, the first air supply flow path 15, the second air supply flow path 16, the first air discharge flow path 17, and a second air discharge flow path 218. Accordingly, a component common to that of the second embodiment will be denoted by the same reference sign in the present embodiment, and detailed description thereof will be omitted.

The second air discharge flow path 218 is an example of a pipe in the claims.

Through the second air discharge flow path 218, the air A4 is discharged from the inner space of the regeneration unit 12 to the outside of the housing 101.

The second air discharge flow path 218 includes a connection portion 218C connected to the vent 132. On the other hand, one end 218A of the second air discharge flow path 218 is opened in the outside of the housing 101. The second air discharge flow path 218 is inclined so that the connection portion 218C of the second air discharge flow path 218 is located below the one end 218A of the second air discharge flow path 218. Thereby, the atomized droplet W3 is discharged to the outside of the housing 101 via the second air discharge flow path 218. On the other hand, the coarse droplet W4 is easily attached to an inner wall of the second air discharge flow path 218 when passing through the second air discharge flow path 218. The attached coarse droplet W4 gravitationally drops and is returned to the hygroscopic liquid W2 in the second storage tank 121.

An inclination angle θ of the second air discharge flow path 218 when a ground contact surface of the humidity control device 210 is set as a reference depends on viscosity of the hygroscopic liquid, but is, for example, 5 degrees or more, preferably 10 degrees or more, and more preferably 20 degrees or more. When the inclination angle θ is 5 degrees or more, the coarse droplet W4 attached to the inner wall of the second air discharge flow path 218 easily gravitationally drops. Moreover, the inclination angle θ of the second air discharge flow path 218 may be 30 degrees or less.

The second air discharge flow path 218 may extend to the inner space of the second storage tank 121. At this time, it is preferable that an end of the second air discharge flow path 218, which is positioned in the inner space of the second storage tank 121, is positioned below the connection portion 218C.

The second air discharge flow path 218 may be curved or bent between the one end 218A and the connection portion 218C in the second air discharge flow path 218. It is preferable that the second air discharge air flow path 218 is curved because a pressure loss of the air A4 is able to be kept low as compared to a case where the second air discharge flow path 218 is bent.

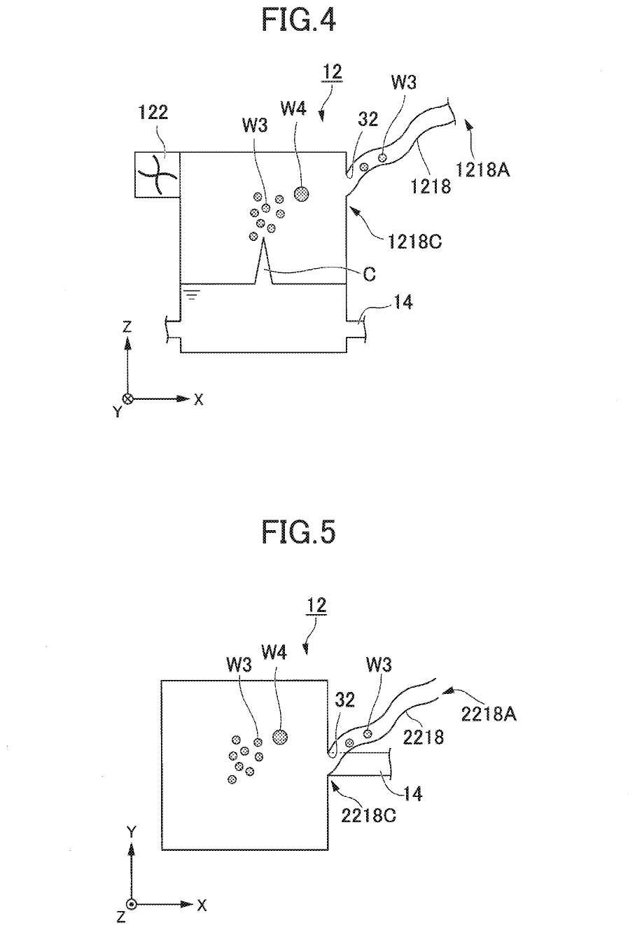

FIG. 4 illustrates a schematic configuration of a modified example of the second air discharge flow path 218. A second air discharge flow path 1218 of FIG. 4 is curved between one end 1218A and a connection portion 1218C in the second air discharge air flow path 1218 in an XZ plane. Thereby, when passing through the second air discharge flow path 1218, the coarse droplet W4 is more likely to collide with an inner wall of the second air discharge flow path 1218 than with the second air discharge flow path 218 of FIG. 3.

FIG. 5 illustrates a schematic configuration of another modified example of the second air discharge flow path 218. A second air discharge flow path 2218 of FIG. 5 is curved between one end 2218A and a connection portion 2218C in the second air discharge air flow path 2218 in an XY plane. In a case where the humidity control device 210 has more room in space in a Y direction than in a Z direction, the second air discharge flow path 2218 is able to be largely curved as compared to the second air discharge flow path 1218 of FIG. 4. As a result, when passing through the second air discharge flow path 2218, the coarse droplet W4 is more likely to collide with an inner wall of the second air discharge flow path 2218 than with the second air discharge flow path 1218 of FIG. 4.

The humidity control device of the present embodiment is able to regenerate the hygroscopic liquid with low energy, similarly to the humidity control device of the first embodiment.

According to the humidity control device of the present embodiment, it is possible to suppress leakage of a hygroscopic substance, similarly to the humidity control device of the first embodiment. Accordingly, the humidity control device of the present embodiment is able to keep dehumidification efficiency even in a case where the humidity control device 10 is repeatedly used, similarly to the humidity control device of the first embodiment.

### Fourth Embodiment

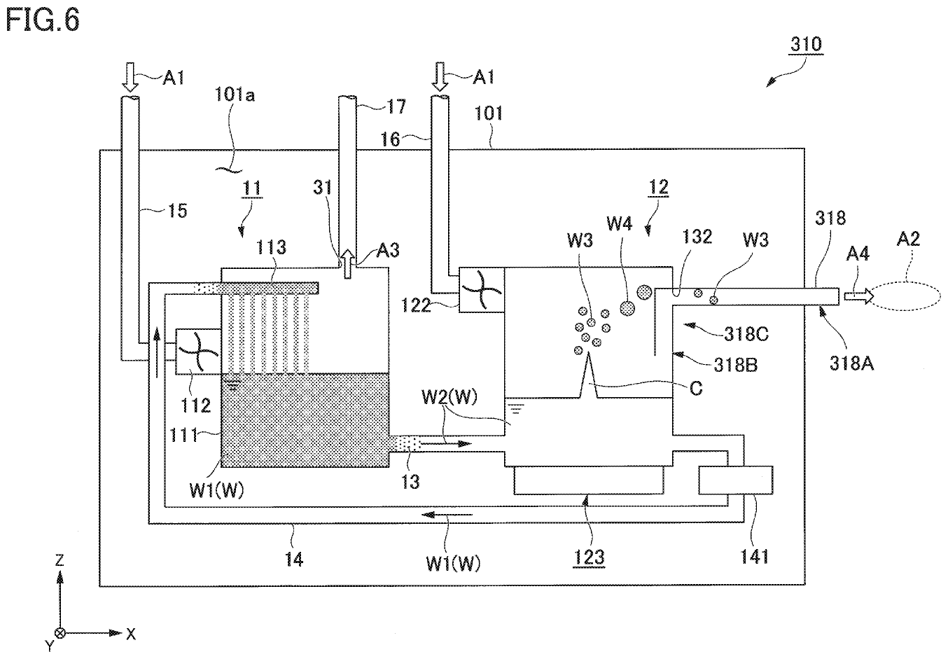

Hereinafter, a humidity control device in a fourth embodiment of the invention will be described with reference to FIG. 6.

### Humidity Control Device

FIG. 6 illustrates a schematic configuration of a humidity control device 310 of the fourth embodiment. As illustrated in FIG. 6, the humidity control device 310 of the fourth embodiment includes the housing 101, the moisture absorption unit 11, the regeneration unit 12, the first liquid transport flow path 13, the second liquid transport flow path 14, the first air supply flow path 15, the second air supply flow path 16, the first air discharge flow path 17, and a second air discharge flow path 318. Accordingly, a component common to that of the second embodiment will be denoted by the same reference sign in the present embodiment, and detailed description thereof will be omitted.

The second air discharge flow path 318 is an example of the pipe in the claims.

Through the second air discharge flow path 318, the air A4 is discharged from the inner space of the regeneration unit 12 to the outside of the housing 101.

The second air discharge flow path 318 includes a connection portion 318C that is connected to the vent 132. On the other hand, one end 318A of the second air discharge flow path 318 is opened in the outside of the housing 101. The other end 318B of the second air discharge flow path 318 extends to the inner space of the second storage tank 121 so that the other end 318B is located below the connection portion 318C of the second air discharge flow path 318. The second air discharge flow path 318 is bent between the other end 318B and the connection portion 318C in the second air discharge flow path 318. Thereby, in a humidity control method described later, it is possible to suppress intrusion of the coarse droplet W4 from the vent 132 to the second air discharge flow path 318 by traveling along an inner wall of the second storage tank 121, or intrusion thereof from the liquid surface of the hygroscopic liquid W2 directly to the second air discharge flow path 318.

A position of the other end 318B of the second air discharge flow path 318 is preferably below an extended line that extends from the ultrasonic wave generation unit 123 to the vent 132, for example. Thereby, the humidity control device 310 is able to suppress intrusion of the coarse droplet W4 from the vent 132 to the second air discharge flow path 318.

Note that, the second air discharge flow path 318 may be curbed between the other end 318B and the connection portion 318C in the second air discharge flow path 318. Thereby, a pressure loss of the air A4 is able to be reduced.

The humidity control method using the humidity control device of the present embodiment enables to regenerate the hygroscopic liquid with low energy, similarly to the humidity control method of the first embodiment.

According to the humidity control method of the present embodiment, it is possible to suppress leakage of a hygroscopic substance, similarly to the humidity control method of the first embodiment. Accordingly, the humidity control method of the present embodiment enables to keep dehumidification efficiency even in a case where the humidity control device 10 is repeatedly used, similarly to the humidity control device of the first embodiment.

### Fifth Embodiment

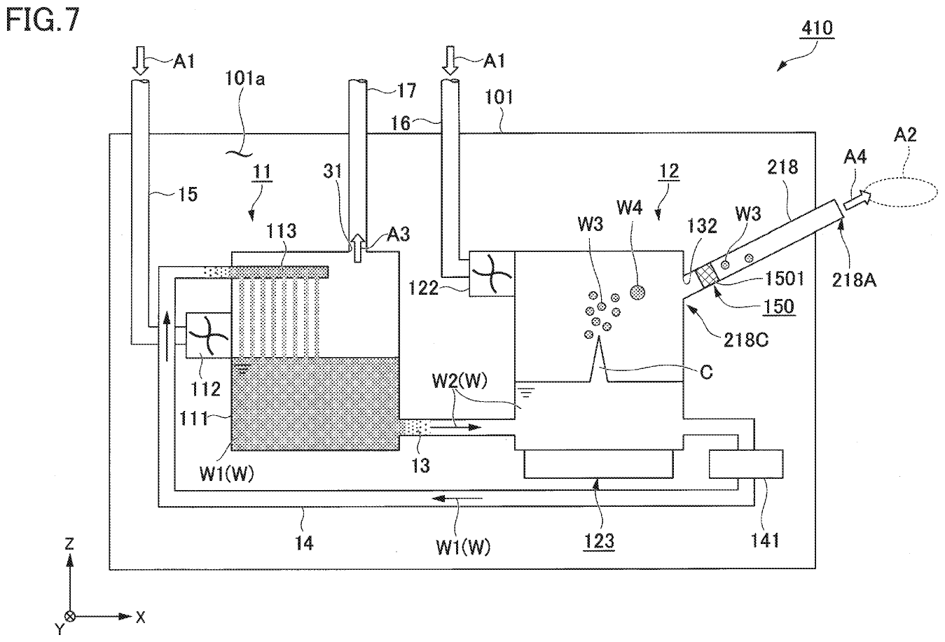

Hereinafter, a humidity control device in a fifth embodiment of the invention will be described with reference to FIG. 7.

### Humidity Control Device

FIG. 7 illustrates a schematic configuration of a humidity control device 410 of the fifth embodiment. As illustrated in FIG. 7, the humidity control device 410 of the fifth embodiment includes the housing 101, the moisture absorption unit 11, the regeneration unit 12, the first liquid transport flow path 13, the second liquid transport flow path 14, the first air supply flow path 15, the second air supply flow path 16, the first air discharge flow path 17, the second air discharge flow path 218, and a separation unit 150. Accordingly, a component common to that of the third embodiment will be denoted by the same reference sign in the present embodiment, and detailed description thereof will be omitted.

### Separation Unit 150

The separation unit 150 separates an atomized droplet and a coarse droplet when the air A4 that contains droplets generated from the hygroscopic liquid W2 passes. The separation unit 150 includes a demister 1501.

The demister 1501 separates the coarse droplet W4 from the air A4 that contains the droplets generated from the hygroscopic liquid W2. The demister 1501 is provided in an inside of the second air discharge flow path 218. Note that, the one end 218A of the second air discharge flow path 218 may be in a direction other than an upper side of a position where the demister 1501 is provided.

A size of a mesh of the demister 1501 is larger than the particle size of the atomized droplet W3 and smaller than the particle size of the coarse droplet W4. Thereby, the atomized droplet W3 passes through the demister 1501 of the separation unit 150 and is discharged to the outside of the housing 101 via the second air discharge flow path 218. On the other hand, the coarse droplet W4 whose particle size is larger than that of the atomized droplet W3 is collected by the demister 1501 of the separation unit 150. The collected coarse droplet W4 gravitationally drops and is returned to the hygroscopic liquid W2 in the second storage tank 121.

Note that, the demister 1501 may cover the vent 132 of the second storage tank 121 from the inner side of the second storage tank 121. Moreover, the demister 1501 may be provided in both of the inside of the second air discharge flow path 218 and a side surface on the inner side of the second storage tank 121.

The humidity control method using the humidity control device of the present embodiment enables to regenerate the hygroscopic liquid with low energy, similarly to the humidity control method of the first embodiment.

According to the humidity control device of the present embodiment, by using the second air discharge flow path 218 and the demister 1501 together, it is possible to prevent an outflow of the coarse droplet W4. As a result, the humidity control device of the present embodiment is able to further suppress leakage of a hygroscopic substance. Accordingly, the humidity control device of the present embodiment is able to further keep dehumidification efficiency even in a case where the humidity control device 10 is repeatedly used. The humidity control device of the present embodiment is effective, for example, in a case where a length of the second air discharge flow path 218 in a longitudinal direction is shorter than that in the humidity control device 10 of the third embodiment.

### Sixth Embodiment

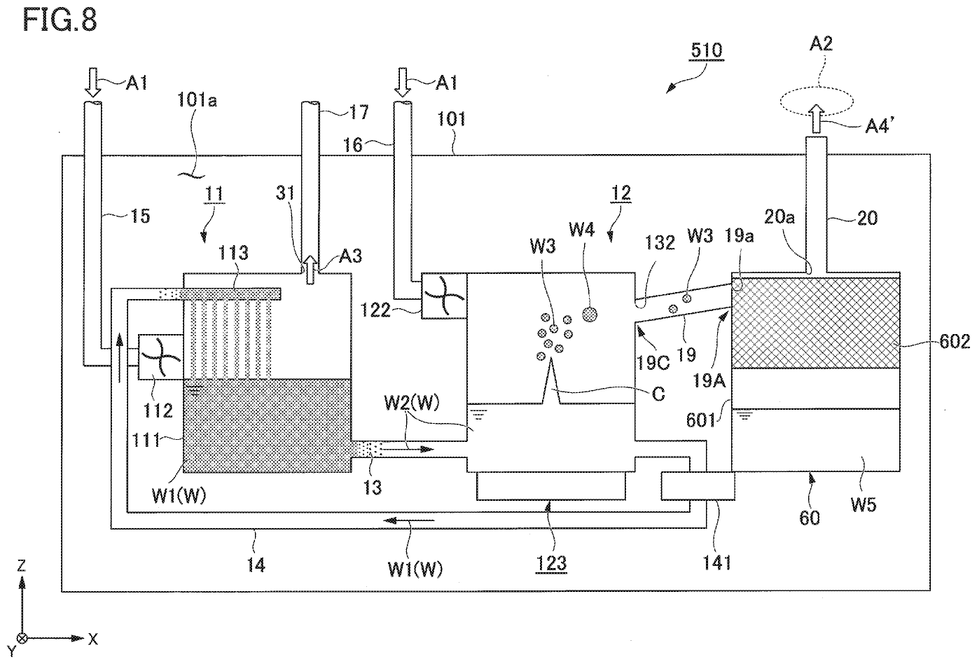

Hereinafter, a humidity control device in a sixth embodiment of the invention will be described with reference to FIG. 8.

### Humidity Control Device

FIG. 8 illustrates a schematic configuration of a humidity control device 510 of the sixth embodiment. As illustrated in FIG. 8, the humidity control device 510 of the sixth embodiment includes the housing 101, the moisture absorption unit 11, the regeneration unit 12, the first liquid transport flow path 13, the second liquid transport flow path 14, the first air supply flow path 15, the second air supply flow path 16, the first air discharge flow path 17, an air transport flow path 19, a third air discharge flow path 20, and a collection unit 60. Accordingly, a component common to that of the second embodiment will be denoted by the same reference sign in the present embodiment, and detailed description thereof will be omitted.

Through the air transport flow path 19, the air A4 is transported from the inner space of the regeneration unit 12 to an inner space of the collection unit 60. The air transport flow path 19 includes a connection portion 19C that is connected to the vent 132. On the other hand, one end 19A of the air transport flow path 19 is connected to the collection unit 60. The air transport flow path 19 is inclined so that the connection portion 19C of the air transport flow path 19 is located below the one end 19A of the air transport flow path 19. Thereby, the atomized droplet W3 is discharged to the inner space of the collection unit 60 via the air transport flow path 19. On the other hand, the coarse droplet W4 is easily attached to an inner wall of the air transport flow path 19 when passing through the air transport flow path 19. The attached coarse droplet W4 gravitationally drops and is returned to the hygroscopic liquid W2 in the second storage tank 121.

Through the third air discharge flow path 20, air A4′ is discharged from the inner space of the collection unit 60 to the outside of the housing 101. Note that, the air A4′ is air an amount of the atomized droplet W3 of which is smaller than that of the air A4.

### Collection Unit

The collection unit 60 collects at least a part of the atomized droplet W3. The collection unit 60 includes a collector 601 and a filter 602. The collection unit 60 is a so-called coalescer that performs gas-liquid separation of the air A4 that contains the atomized droplet W3 into the atomized droplet W3 and the air A4′ by the filter 602.

The air transport flow path 19 is connected to a side part of the collection unit 60. The third air discharge flow path 20 is connected to an upper part of the collection unit 60.

The collector 601 stores liquid W5 that is obtained by collecting a part of the atomized droplet W3. As described above, it is considered that the atomized droplet W3 whose particle size is small is difficult to contain a hygroscopic substance. Thus, the liquid W5 is considered to be almost water.

By the filter 602, the air A4 that contains the atomized droplet W3 is subjected to gas-liquid separation into atomized droplet W3 and the air A4′. The filter 602 is arranged in an inside of the collector 601. The filter 602 is arranged in a middle of an air flow directed from a supply port 19a of the air transport flow path 19 to a discharge port 20a of the third air discharge flow path 20.

The filter 602 is composed of ultrafine fiber. The atomized droplet W3 is attached to the fiber of the filter 602 and aggregated. The aggregated atomized droplet W3 drops by its own weight and is stored in the collector 601 as the liquid W5.

Note that, the atomized droplet W3 is considered to gradually evaporate while being transported. From a viewpoint of efficient collection of the atomized droplet W3, it is preferable that a length of the air transport flow path 19 is shortened within a range that does not impair an effect of the invention.

The humidity control method using the humidity control device of the present embodiment enables to regenerate the hygroscopic liquid with low energy, similarly to the humidity control method of the first embodiment.

According to the humidity control device of the present embodiment, it is possible to suppress leakage of a hygroscopic substance, similarly to the humidity control device of the first embodiment. Accordingly, the humidity control device of the present embodiment is able to keep dehumidification efficiency even in a case where the humidity control device 10 is repeatedly used, similarly to the humidity control device of the first embodiment. According to the humidity control device of the present embodiment, it is possible to reuse moisture collected by the collection unit 60.

Though the embodiments of the invention have been described above, configurations, a combination thereof, and the like in the embodiments are merely examples, and addition, omission, replacement, and another modification of a configuration may be allowed in a range without departing from the spirit of the invention. Moreover, the invention is not limited by the embodiments.

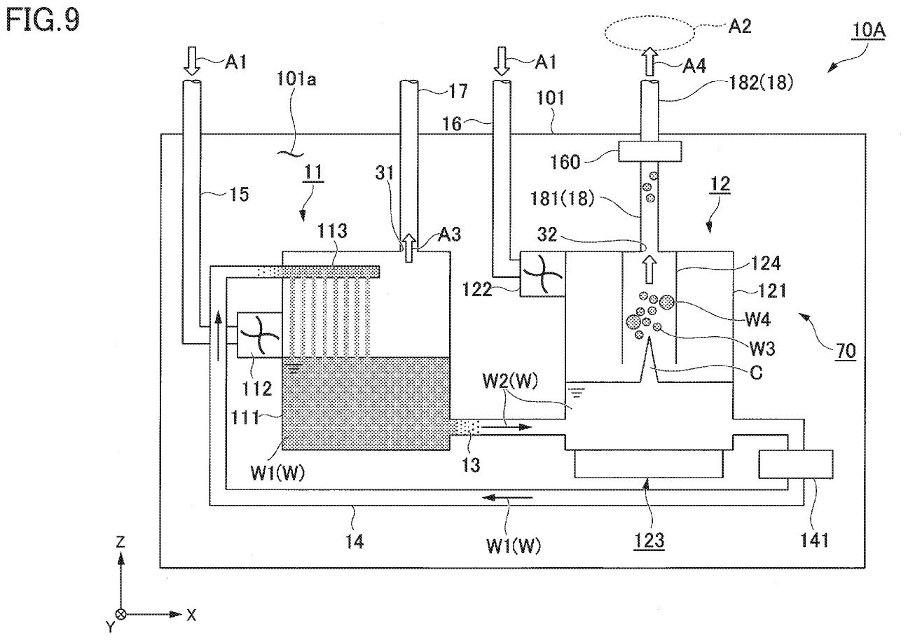

For example, the humidity control device 10 of FIG. 1 may include a collection unit that collects an atomized droplet. FIG. 9 illustrates a part of a schematic configuration of a modified example of the humidity control device 10 of the first embodiment. As illustrated in FIG. 9, a humidity control device 10A includes a collection unit 160 in a middle of the second air discharge flow path 18. The second air discharge flow path 18 has a first transport flow path 181 and a second transport flow path 182. By the first transport flow path 181, the inner space of the regeneration unit 12 and an inner space of the collection unit 160 are connected. By the second transport flow path 182, the inner space of the collection unit 160 and the outside of the housing 101 are connected.

According to the humidity control device 10A, it is possible to reuse moisture collected by the collection unit 160.

When being viewed from another side surface, the humidity control device 10A includes a separation device 70 that separates moisture (solvent) from the hygroscopic liquid W2 (solution). The separation device 70 includes the regeneration unit 12 (storage unit) that stores the hygroscopic liquid W2, the collection unit 160 that collects separated liquid, the ultrasonic wave generation unit 123 that irradiates at least a part of the hygroscopic liquid W2 with an ultrasonic wave, the blower 122 (swirl flow generation unit) that generates a swirl flow of gas in the inside of the regeneration unit 12, and the first transport flow path 181 by which the regeneration unit 12 and the collection unit 160 are connected.

The separation device 70 separates moisture by separating the generated atomized droplet W3 from the hygroscopic liquid W2 by the swirl flow and suppresses an outflow of the coarse droplet W4 whose particle size is larger than that of the atomized droplet W3.

In the humidity control device of an aspect of the invention, the moisture absorption unit and the regeneration unit may be integrally provided. Thereby, reduction in size of the device is able to be achieved as compared with the humidity control device in which the moisture absorption unit and the regeneration unit are separately provided.

In the humidity control device of an aspect of the invention, a contact system of air is not limited to the flow-down system.

The contact system of air may be a so-called stand-still system that is a system in which the hygroscopic liquid W1 stands still in an air flow of the air A1.

The contact system of air may be a so-called spray system that is a system in which the hygroscopic liquid W1 in an atomized state is sprayed in an air flow of the air A1.

The contact system of air may be a so-called bubbling system that is a system in which a bubble of the air A1 is brought into contact in the hygroscopic liquid W1.

The contact system of air may be a so-called column system that is a system in which a column is impregnated with the hygroscopic liquid W in an air flow of the air A1.

1. A humidity control device comprising:
a storage unit that stores hygroscopic liquid that contains a hygroscopic substance;
a vent that is provided in the storage unit;
absorption means by which air and the hygroscopic liquid are brought into contact with each other and moisture contained in the air is absorbed by the hygroscopic liquid;
an ultrasonic wave generation unit that irradiates at least a part of the hygroscopic liquid, which has absorbed the moisture, with an ultrasonic wave; and
removal means by which an atomized droplet that is generated is removed from the hygroscopic liquid that has absorbed the moisture, wherein
the storage unit suppresses an outflow of a coarse droplet whose particle size is larger than that of the atomized droplet.

2. The humidity control device according to claim 1 comprising a collection unit that collects at least a part of the atomized droplet.

3. The humidity control device according to claim 1, wherein the storage unit includes a separation unit that separates the atomized droplet and the coarse droplet.

4. The humidity control device according to claim 3, wherein the separation unit includes a cyclone separator.

5. The humidity control device according to claim 3, wherein the separation unit includes a demister.

6. The humidity control device according to claim 1, wherein
the vent includes a first vent and a second vent,
the storage unit includes a first storage unit, a second storage unit, and a flow path by which the first storage unit and the second storage unit are connected,
the first storage unit includes the absorption means and the first vent, and
the second storage unit includes the ultrasonic wave generation unit, the removal means, and the second vent.

7. The humidity control device according to claim 1, wherein
the vent is provided in a side part of the storage unit,
the storage unit is provided with a pipe that includes a connection portion connected to the vent,
one end of the pipe is opened in an outside of the storage unit, and
the pipe is inclined so that the connection portion is located below the one end of the pipe.

8. The humidity control device according to claim 7, wherein the pipe is curved or bent.

9. The humidity control device according to claim 7, wherein the pipe extends to an inside of the storage unit so that the other end of the pipe is located below the connection portion.

10. The humidity control device according to claim 1, wherein
the vent is provided in a side part of the storage unit,
the storage unit is provided with a pipe that includes a connection portion connected to the vent,
one end of the pipe is opened in an outside of the storage unit, and
the pipe extends to an inside of the storage unit so that the other end of the pipe is located below the connection portion.

11. The humidity control device according to claim 7, wherein the storage unit includes a separation unit that separates the atomized droplet and the coarse droplet.

12. The humidity control device according to claim 11, wherein the separation unit includes a demister.

13. The humidity control device according to claim 12, wherein the demister is provided in an inside of at least any one of the storage unit and the pipe.

14. The humidity control device according to claim 7, wherein
the vent includes a first vent and a second vent,
the storage unit includes a first storage unit, a second storage unit, and a flow path by which the first storage unit and the second storage unit are connected,
the first storage unit includes the absorption means and the first vent,
the second storage unit includes the ultrasonic wave generation unit, the removal means, the second vent, and the pipe, and
the pipe is connected to the second vent.

15. A separation device that separates solvent from solution, the separation device comprising:
a storage unit that stores the solution;
a collection unit that collects the solvent that is separated;
an ultrasonic wave generation unit that irradiates at least a part of the solution with an ultrasonic wave;
a swirl flow generation unit that generates a swirl flow of gas in an inside of the storage unit; and
a pipe by which the storage unit and the collection unit are connected, wherein
the swirl flow causes an atomized droplet that is generated from the solution to be separated so that the solvent is separated, and an outflow of a coarse droplet whose particle size is larger than that of the atomized droplet is suppressed.
